(19) United States
(12) Patent Application Publication
(10) Pub. No.: US 2003/0033226 A1
(43) Pub. Date: Feb. 13, 2003

(54) Web-based time and activity tracking systems and methods

(76) Inventor: Eric S. Anderson, Loveland, OH (US)

Correspondence Address: Christopher L. Bernard, Esq., KILPATRICK STOCKTON LLP, 301 So. College St., 3500 One First Union Center, Charlotte, NC, 28202, US

(21) Appl. No.: 09/928,935

(22) Filed: Aug. 13, 2001

(51) Int. Cl. G06F 17/60

(52) U.S. Cl. 705/32

(57) ABSTRACT

Globally-accessible, computerized systems and methods for tracking the time associated with the completion of an activity including an activity template having a plurality of data fields which may be populated by one or more activity performers and a time tracking module operable for receiving information related to the activity from the one or more activity performers, updating the plurality of data fields based upon the information, and generating performance reports related to the activity. The time and activity tracking systems and methods also including one or more filters operable for ensuring that information related to the activity is received from only valid activity performers and that the information is associated with only a valid activity, and a communications network operable for transmitting information related to the activity between the one or more activity performers and the time tracking module.

### BACKGROUND OF THE INVENTION

The present invention relates generally to globally-accessible, computerized systems and methods for tracking time associated with the completion of a given activity or set of activities and, more specifically, to web-based systems and methods for tracking service technician time associated with the completion of a given service activity or set of service activities.

Businesses engaged in service-oriented activities, as well as others, often utilize manual time and activity tracking systems, including vacation time tracking systems, and manual payroll timesheets. These systems, although marginally effective, suffer from several important limitations. First, it is often difficult for service technicians to enter the time spent on a given activity into such systems. For example, a service technician may have to record his or her time on paper. This information must then be submitted, either physically, via telephone, via facsimile, or otherwise, to a support center representative or other operator who enters the time into the system. Alternatively, such manual time and activity tracking systems may be equipped with remote terminals or hand-held time tracking devices which service technicians may use to enter their own time. Conventional remote terminal systems are often inconvenient as they may require a service technician to enter his or her time into the system from a small number of predetermined locations. Likewise, conventional hand-held device systems may require a service technician to periodically download his or her time from the device into the system. Second, the reports generated by many manual time and activity tracking systems include an inherent time lag and lack the robustness necessary for the effective and efficient management of service technician time. Third, such systems typically do not include conflict avoidance mechanisms, making it possible for a given service technician to be scheduled to work on multiple activities simultaneously, i.e. “double-booked”.

Thus, what is needed are globally-accessible, computerized time and activity tracking systems and methods which allow a service technician to enter his or her time and activity information quickly and easily from virtually any location via the Internet. These systems and methods should provide an intuitive interface, increasing the accuracy of data entry. They should also allow a service technician to review his or her time entries before submitting them to management. What is also needed are systems and methods which allow management to generate robust, real-time reports. These reports should allow management to view service technician time and activity information hierarchically. Further, what is needed are systems and methods which incorporate a conflict avoidance mechanism, eliminating the problem of double-booking. Finally, what is needed are systems and methods which may be interfaced with a service initiation program, such that calls coming into a service center automatically result in the generation of activities in the system and the assignment of one or more service technicians to those activities. These activities should include fields which may be populated by the service technician(s).

### BRIEF SUMMARY OF THE INVENTION

The present invention overcomes the above limitations and provides globally-accessible, computerized systems and methods for tracking the time associated with the completion of a given activity or set of activities.

In one embodiment, a computerized system for tracking the time associated with the completion of an activity includes an activity template having a plurality of data fields which may be populated by one or more activity performers and a time tracking module operable for receiving information related to the activity from the one or more activity performers, updating the plurality of data fields based upon the information, and generating performance reports related to the activity. The time and activity tracking system also includes one or more filters operable for ensuring that information related to the activity is received from only valid activity performers and that the information is associated with only a valid activity, and a communications network operable for transmitting information related to the activity between the one or more activity performers and the time tracking module.

In another embodiment, a computerized method for tracking the time associated with the completion of an activity includes establishing an activity template, having a plurality of data fields, which may be populated by one or more activity performers and receiving information related to the activity, via a time tracking module, from the one or more activity performers. The time and activity tracking method also includes ensuring that the information related to the activity is received from only valid activity performers and that the information is associated with only a valid activity. The time and activity tracking method further includes updating the plurality of data fields based upon the information received from the one or more activity performers, generating performance reports related to the activity, and transmitting information related to the activity between the one or more activity performers and the time tracking module via a communications network.

### BRIEF DESCRIPTION OF THE DRAWINGS

FIG. 1 is a functional block diagram of one embodiment of a globally-accessible system for tracking the time associated with the completion of a given activity or set of activities;

FIG. 2 is a schematic diagram of one embodiment of an operating environment for the globally-accessible time and activity tracking system of FIG. 1; and

FIG. 3 is a functional block diagram of one embodiment of a computer system comprising the globally-accessible time and activity tracking system of FIG. 1.

### DETAILED DESCRIPTION OF THE INVENTION

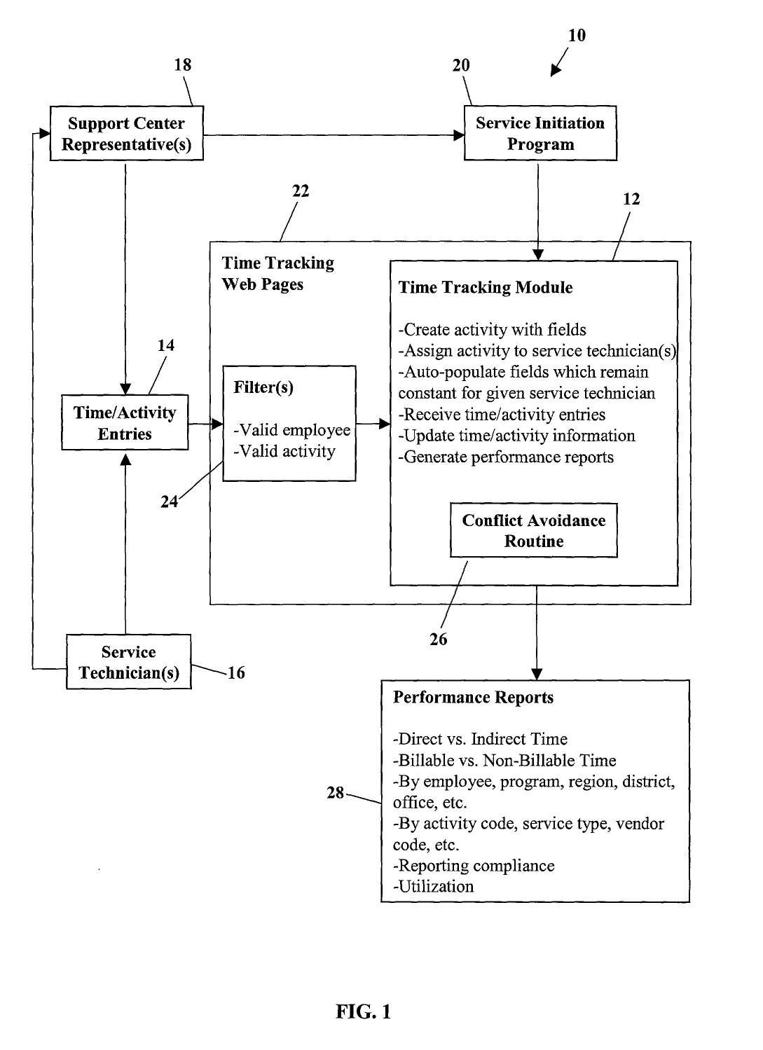

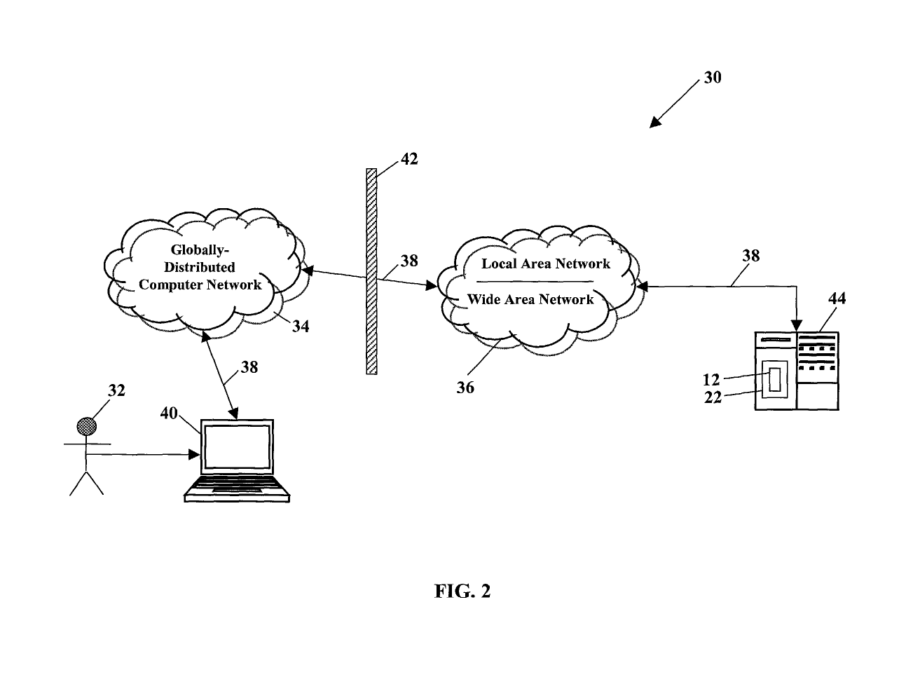

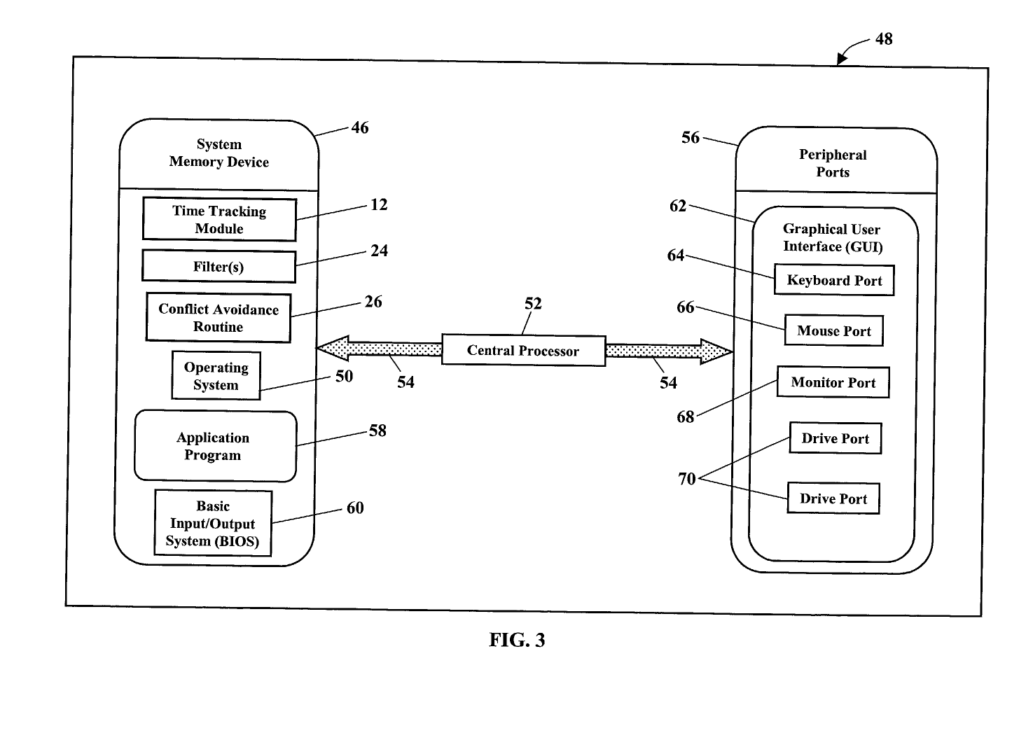

Referring to FIG. 1, in one embodiment, a globally-accessible time and activity tracking system 10 includes a time tracking module 12 operable for receiving, storing, and processing information related to one or more activities, which may be, for example, service-oriented activities. This activity-related information may include, for example, authorization/verification information, employee information (such as employee type information, office phone numbers, home phone numbers, cell phone numbers, fax numbers, pager numbers, email addresses, etc.), availability information (such as on-call time, vacation time, etc.), and time/activity entries 14 (such as billable/non-billable hours recorded to a given activity). The time tracking module 12 may receive the activity-related information from a plurality of sources including, for example, one or more service technicians 16, one or more support center representatives 18 or other operators, or a service initiation program 20. For example, the time tracking module 12 may receive instructions from a service initiation program 20, such as “Clarify”, directing the module 12 to establish an activity template in the system 10 to which time may be recorded and to assign one or more available, appropriate service technicians 16 to that activity. Each service technician 16 may then record his or her time to the activity by accessing one or more time tracking web pages 22 via the Internet. The web pages 22 are preferably secure and may include a plurality of dynamic menus, drop-down lists, links, and the like, displayed via a graphical user interface (GUI) 62 (FIG. 3). Through the web pages 22, a manager, a service technician 16, a support center representative 18 or other operator, or any other authorized remote user 32 (FIG. 2) may view time and activity information, submit information, and query the time tracking module 12.

In operation, the time tracking web pages 22 may require a remote user 32 to enter a user name and a password. They may also allow a remote user 32, once properly authorized/verified, to change his or her user name and password. The web pages 22 may then display such information as an employee identification number, program information, region information, district information, office information, and time and activity information for a given period. The time and activity information may include, for example, an activity code, an activity type, a start date, billable hour information, non-billable hour information, information regarding time billed, service type information, a vendor code, a work order number, a service order number, and a customer ticket number. The remote user 32, which may be, for example, a service technician 16, may edit his or her timesheet by entering data into the appropriate fields. He or she may also view the “open” timesheet and submit it to management, or “close” it. The remote user 32 may also enter scheduling and availability information, including notes, into the system 10, such that the time tracking module 12 may assign one or more available, appropriate service technicians 16 to each activity. Each service technician 16 may then query the time tracking web pages 22 to determine to which activities he or she has been assigned/dispatched. In operation, this is accomplished with the aide of calendar and “appointment book”-type displays. The time tracking module 12 preferably includes one or more filters 24 operable for screening time/activity entries 14 such that only valid employees are allowed to enter data, and that data is recorded only to valid activities. The time tracking module 12 is also preferably operable for auto-populating fields which remain constant for a given service technician 16 and includes a conflict avoidance routine 26, eliminating the problem of service technician 16 double-booking.

Alternatively, a service technician 16 may report his or her time and activity information to a support center representative 18 or other operator who, in turn, may enter the information into the time and activity tracking system 10 via the web pages 22. Information which may be provided by the service technician 16 to the support center representative 18 includes, for example, an employee CSR code, the date being logged, the time being logged, the type of hours (regular, overtime, on-call, etc.), the actual hours, a billable/non-billable designation, the service type, an activity code, a vendor code, the location/program, a service order number, and a customer ticket number.

Using the time and activity tracking system 10, management and administration may approve submitted schedules and timesheets, and may generate related performance reports 28 which contain useful business information. Such reports 28 may include, for example, logged hours vs. possible hours reports (showing the number of hours that were logged versus the number of hours that should have been logged by a region, district, office, or employee, indicating who is correctly and consistently tracking their time), billable hours vs. non-billable hours reports (showing the number of billable hours that were logged versus the number of non-billable hours that were logged by a region, district, office, or employee, indicating which resources are being used efficiently), service type reports (showing the percentage of logged hours spent on each service type by a region, district, office, or employee), vendor reports (showing the percentage of time billed to each vendor by a region, district, office, or employee), activity reports (showing the percentage of logged hours spent on each activity by a region, district, office, or employee), and weekly payroll inquiry reports (tracking the type of hours logged by an employee for payroll purposes—regular, overtime, on-call, etc.). These reports 28 are preferably displayed via the graphical user interface (GUI) 62 and may include color-coded bar charts, pie charts, and line graphs. These reports 28 may also, optionally, be downloaded into an appropriate spreadsheet application (such as MS Excel, Microsoft Corporation, Redmond, Wash.) and printed.

Referring to FIG. 2, in one embodiment, an operating environment 30 for the globally-accessible time and activity tracking system 10 (FIG. 1), including the time tracking module 12 discussed above, includes a remote user 32 linked to the time tracking web pages 22 via a globally-distributed computer network 34, such as the Internet or an intranet, and/or a local area network/wide area network (LAN/WAN) 36. This link may be established along one or more data communications lines 38, or via wireless interfaces. The remote user 32 may view, submit, and query information at the time tracking web pages 22 through a browser application run by a local computer 40, such as a desktop or laptop personal computer. Via the time tracking web pages 22, the remote user 32 is linked, through a firewall 42, to the time tracking module 12 which receives, stores, and processes information related to one or more activities. The time tracking web pages 22 may reside in a persistent storage device 44, such as an application server, a web server, a file server, or a database server. The operating environment 30 is set up such that the persistent storage device 44 may communicate information to and receive information from a plurality of remote users 32 simultaneously.

Referring to FIG. 3, in one embodiment, the time tracking module 12, the one or more filters 24, and the conflict avoidance routine 26 comprise one or more computer programs which acquire time and activity-related data, store and archive the data, manipulate the data, and formulate outputs which may be viewed and queried by the remote user 32 (FIG. 2). The time tracking module 12 preferably resides within the system memory device 46 of a computer system 48, which may, optionally, be an application server, a web server, a file server, or a database server. The system memory device 46 may include a random-access memory (RAM) and a read-only memory (ROM). The system memory device 46 may also include other types of memory, such as programmable read-only memory (PROM), erasable programmable read-only memory (EPROM), and electrically erasable programmable read-only memory (EEPROM). The system memory device 46 also preferably includes an operating system 50 that executes on a central processor 52. The central processor 52 may be, for example, a microprocessor. Suitable examples of microprocessors include, but are not limited to, those manufactured by Advanced Micro Devices, Inc. (Sunnyvale, Calif.), Intel Corporation (Santa Clara, Calif.), Motorola, Inc. (Schaumburg, Ill.), International Business Machines Corp. (Armonk, N.Y.), and Transmeta Corp. (Santa Clara, Calif.). The central processor 52 may include an arithmetic logic unit (ALU), which performs arithmetic and logic operations, and a control unit, which extracts instructions from the system memory device 46. The operating system 50 may include a set of instructions which control the internal functions of the computer system 48. For example, the operating system 50 may recognize input from input devices, send output to output devices, keep track of directories and files, and control various peripheral devices. Suitable examples of operating systems 50 include, but are not limited to, those manufactured by Microsoft Corporation (Redmond, Wash.) and Apple Computer, Inc. (Cupertino, Calif.). A system bus 54 may communicate signals, such as address signals, data signals, and control signals, between the system memory device 46, the central processor 52, and one or more peripheral ports 56. The system memory device 46 may also contain an application program 58 and a basic input/output system (BIOS) 60. The application program 58 cooperates with the operating system 50 and the one or more peripheral ports 56 to provide a graphical user interface (GUI) 62. The GUI 62 typically includes a combination of signals communicated along a keyboard port 64, a mouse port 66, a monitor port 68, and one or more drive ports 70. The BIOS 60 may interpret requests from the operating system 50 and interface with such ports to execute the requests. Accordingly, suitable input/output devices include a keyboard, a mouse, a monitor, a printer, a plotter, speakers, etc.

The systems, methods, programs, and processes described in relation to the present invention are not limited to any particular computer system. The computer system 48 may be a single device, or it may be a plurality of devices working in concert. The computer system 48 may take the form of a hand-held digital computer, a personal digital assistant (PDA), a personal computer (PC), a workstation, a server, a mainframe computer, and a supercomputer.

It is apparent that there has been provided, in accordance with the present invention, web-based systems and methods for tracking the service technician time associated with the completion of a given service activity or set of service activities. While the present invention has been particularly shown and described in conjunction with examples and preferred embodiments thereof, it will be appreciated that variations in and modifications to the present invention may be effected by persons of ordinary skill in the art without departing from the spirit or scope of the present invention. For example, the computerized systems and methods of the present invention may be used for tracking the time associated with the completion of a wide array of activities, not simply service-oriented activities. It is therefore to be understood that the principles described herein apply in a similar manner, where applicable, to all examples and preferred embodiments.

What is claimed is:

1. A computerized system for tracking the time associated with the completion of an activity, the system comprising:
an activity template including a plurality of data fields which are populated by one or more activity performers;
a time tracking module operable for receiving information related to the activity from the one or more activity performers, updating the plurality of data fields based upon the information, and generating performance reports related to the activity;
one or more filters operable for ensuring that information related to the activity is received from only valid activity performers and that the information is associated with only a valid activity; and
a communications network operable for transmitting information related to the activity between the one or more activity performers and the time tracking module.

2. The time and activity tracking system of claim 1, further comprising an initiation program operable for generating an activity template in the system and assigning one or more activity performers to the activity.

3. The time and activity tracking system of claim 1, further comprising a conflict avoidance routine operable for ensuring that the one or more activity performers are not assigned to conflicting activities.

4. The time and activity tracking system of claim 1, wherein the information related to the activity comprises the time associated with the completion of the activity.

5. The time and activity tracking system of claim 1, wherein the information related to the activity comprises activity performer scheduling and availability information.

6. The time and activity tracking system of claim 1, wherein the communications network comprises a globally-distributed computer network.

7. The time and activity tracking system of claim 6, wherein the communications network further comprises a local area network (LAN).

8. The time and activity tracking system of claim 6, wherein the communications network further comprises a wide area network (WAN).

9. The time and activity tracking system of claim 1, wherein the time tracking module is operable for receiving information related to the activity from the one or more activity performers simultaneously.

10. A computerized system for tracking the time associated with the completion of a service activity, the system comprising:
a service initiation program operable for generating an activity template in the system and assigning one or more service technicians to the activity, the activity template including a plurality of data fields which may be populated by the one or more service technicians;
a conflict avoidance routine operable for ensuring that the one or more service technicians are not assigned to conflicting activities;
a time tracking module operable for receiving information related to the activity from the one or more service technicians, updating the plurality of data fields based upon the information, and generating performance reports related to the activity;
one or more filters operable for ensuring that information related to the activity is received from only valid service technicians and that the information is associated with only a valid activity; and
a communications network operable for transmitting information related to the activity between the one or more service technicians and the time tracking module.

11. The time and activity tracking system of claim 10, wherein the information related to the activity comprises the time associated with the completion of the activity.

12. The time and activity tracking system of claim 10, wherein the information related to the activity comprises service technician scheduling and availability information.

13. The time and activity tracking system of claim 10, wherein the communications network comprises a globally-distributed computer network.

14. The time and activity tracking system of claim 13, wherein the communications network further comprises a local area network (LAN).

15. The time and activity tracking system of claim 13, wherein the communications network further comprises a wide area network (WAN).

16. The time and activity tracking system of claim 10, wherein the time tracking module is operable for receiving information related to the activity from the one or more service technicians simultaneously.

17. A computerized method for tracking the time associated with the completion of an activity, the method comprising:
generating an activity template, including a plurality of data fields which may be populated by one or more activity performers;
receiving information related to the activity, via a time tracking module, from the one or more activity performers;
ensuring that the information related to the activity is received from only valid activity performers and that the information is associated with only a valid activity;
updating the plurality of data fields based upon the information received from the one or more activity performers;
generating performance reports related to the activity; and
transmitting information related to the activity between the one or more activity performers and the time tracking module via a communications network.

18. The time and activity tracking method of claim 17, further comprising assigning one or more activity performers to the activity.

19. The time and activity tracking method of claim 17, further comprising ensuring that the one or more activity performers are not assigned to conflicting activities.

20. The time and activity tracking method of claim 17, wherein the information related to the activity comprises the time associated with the completion of the activity.

21. The time and activity tracking method of claim 17, wherein the information related to the activity comprises activity performer scheduling and availability information.

22. The time and activity tracking method of claim 17, wherein the communications network comprises a globally-distributed computer network.

23. The time and activity tracking method of claim 22, wherein the communications network further comprises a local area network (LAN).

24. The time and activity tracking method of claim 22, wherein the communications network further comprises a wide area network (WAN).

25. The time and activity tracking method of claim 17, further comprising receiving information related to the activity from the one or more activity performers simultaneously.

26. A computerized method for tracking the time associated with the completion of a service activity, the method comprising:
generating an activity template and assigning one or more service technicians to the activity, the activity template including a plurality of data fields which may be populated by the one or more service technicians;
ensuring that the one or more service technicians are not assigned to conflicting activities;
receiving information related to the activity, via a time tracking module, from the one or more service technicians;
ensuring that the information related to the activity is received from only valid service technicians and that the information is associated with only a valid activity;
updating the plurality of data fields based upon the information received from the one or more service technicians;
generating performance reports related to the activity; and
transmitting information related to the activity between the one or more service technicians and the time tracking module via a communications network.

27. The time and activity tracking method of claim 26, wherein the information related to the activity comprises the time associated with the completion of the activity.

28. The time and activity tracking method of claim 26, wherein the information related to the activity comprises service technician scheduling and availability information.

29. The time and activity tracking method of claim 26, wherein the communications network comprises a globally-distributed computer network.

30. The time and activity tracking method of claim 29, wherein the communications network further comprises a local area network (LAN).

31. The time and activity tracking method of claim 29, wherein the communications network further comprises a wide area network (WAN).

32. The time and activity tracking method of claim 26, further comprising receiving information related to the activity from the one or more service technicians simultaneously.
